(19) United States
(12) Patent Application Publication
(10) Pub. No.: US 2010/0025156 A1
(43) Pub. Date: Feb. 4, 2010

(54) Emergency evacuation system for multi-story buildings

(76) Inventor: Mark A. Lewis, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 12/459,898

(22) Filed: Jul. 9, 2009

Related U.S. Application Data
(60) Provisional application No. 61/134,517, filed on Jul. 9, 2008.

(51) Int. Cl. E04G 1/15; E05F 15/20

(52) U.S. Cl. 182/223; 49/31

(57) ABSTRACT

An emergency evacuation system includes one or more walkways that extend from a first multi-story building, at designated floor levels above the ground floor, to an adjacent multi-story building. The emergency walkway has a series of interconnecting, telescopically extendable sections that are normally stowed in a retracted arrangement within the first building. When the emergency walkway is deployed, safety walls raise and lock into an operable, vertical position along the entire length of the walkway, from the first building to the adjacent building. The system may include a rotatable base at the first building to allow adjusted angular positioning of the extended walkway so that the opposite end of the emerging walkway docks at the desired location on the side of the adjacent building. Emergency access to both the first building and the adjacent building, at opposite ends of the walkway, is normally closed and only opens when the emergency evacuation system is deployed.

This application is based on provisional patent application Ser. No. 61/134,517 filed on Jul. 9, 2008 for which applicant claims the benefit under Title 35, United States Code section 119 (e).

### BACKGROUND OF THE INVENTION

1. Field of the Invention

The present invention relates to emergency evacuation systems for buildings and, more particularly, to an emergency evacuation walkway that extends from a first building to an adjacent building, allowing occupants in the first building to evacuate to the adjacent building without having to descend a stairway all the way to the ground floor of the building being evacuated.

2. Discussion of the Related Art

Occasionally, occupants of a building are required to evacuate in response to a fire drill or a real emergency, such as a fire, gas leak, or bomb threat, etc. In a multi-story building, use of the elevators is not permitted during emergency evacuation. Instead, all occupants on the second floor and above must use the stairs, usually located within an emergency stairwell. Older buildings may have an exterior fire escape featuring an arrangement of vertical ladders and/or stairs. While conventional ladder and stairway escape routes have been used extensively in all types of multi-story buildings, including modern skyscrapers, they present significant problems to the elderly and others who may have serious health conditions and/or limited mobility. For handicapped individuals who are confined to a wheelchair, descending a stairway is impossible without the assistance of others. And, those good Samaritans who do render assistance, risk injuring themselves in the process. Often, people who believe themselves to be in good physical health can experience difficulties, and possibly serious problems such as cardiac arrest, due to the stress and physical exertion experienced when descending many flights of stairs in the hectic environment of a confined emergency stairwell, often crowded with panic stricken evacuees. Even during a routine fire drill, there is risk of injury to anyone descending the emergency stairway.

Accordingly, there remains an urgent and definite need for a reliable, safe and highly efficient emergency evacuation system that allows persons of all physical condition, including the elderly and handicapped, to easily and calmly evacuate a high rise building to a safe location. More particularly, there is an urgent need for an evacuation system that provides a safe walkway from one high rise building to an adjacent high rise building at one or more designated floor levels above the ground floor, thereby allowing occupants of the first building to evacuate without having to descend an emergency stairway all the way to the ground floor.

### OBJECTS AND ADVANTAGES OF THE INVENTION

Considering the foregoing, it is a primary object of the present invention to provide an emergency evacuation system for multi-story buildings that provides a walkway that extends from a first building to an adjacent building, at one or more designated floor levels above the ground floor, allowing occupants in the first building to safely, easily and systematically evacuate to the adjacent building without having to descend a stairway all the way to the ground floor of the building being evacuated.

It is a further object of the present invention to provide an emergency evacuation system for multi-story buildings that provides a walkway that extends from a first building to an adjacent building, at one or more designated floor levels above the ground floor, allowing occupants in the adjacent building to safely, easily and systematically evacuate to the first building in the event of an emergency in the adjacent building.

It is a further object of the present invention to provide an extendable evacuation system that is adapted to be stowed within a designated room or compartment within the flooring or infrastructure of the building, and wherein a walkway is structured and disposed to extend outwardly from the side of the building and to an access opening or docking location in an adjacent building to allow occupants of one of the buildings to easily and calmly evacuate the building to the other building by walking, single file, along the extended walkway.

It is still a further object of the present invention to provide an emergency evacuation system including and extendable walkway that extends from a first building to an adjacent second building to allow elderly persons and handicapped persons to easily evacuate the first building by traveling across the extended walkway to the adjacent building, without the need to descend an emergency stairway all of the way to the ground floor of the first building.

It is still a further object of the present invention to provide an emergency evacuation system including an extendable walkway that extends from a first building to an adjacent second building, and wherein the angular extension of the walkway can be adjusted in order to allow the distal end of the walkway to meet at a docking location and/or access opening within the side of the adjacent building.

It is still a further object of the present invention to provide an emergency evacuation system including an extendable walkway that extends from a first building to an adjacent second building to allow occupants of the first building to easily, calmly and systematically evacuate from the first building to the adjacent building, and wherein the extended walkway is provided with safety walls along the opposite sides of the safe walk and along the entire length of the walkway from the building to the adjacent building.

It is yet a further object of the present invention to provide a walkway in an emergency evacuation system, as described above, and wherein the safety side walls of the walkway are collapsible when not in use to allow the walkway to be easily stowed in a room or compartment of the first building.

It is yet a further object of the present invention to provide an extendable walkway in an emergency evacuation system, as described above, and wherein the walkway includes one or more extendable sections that are adapted to extend outwardly from the side of the first building to the adjacent building, and further wherein the extendable section(s) are adapted to retract in a telescoping fashion within one another in a stowed mode within a compartment or designated room along the side of the first building.

It is still a further object of the present invention to provide an emergency evacuation system, as described above, and wherein an emergency exit on the first building is normally closed and opens upon deployment of an extendable walkway, and further wherein an access opening or docking location on the adjacent building opens upon the end of the extendable walkway reaching the access opening or docking location of the adjacent building.

### SUMMARY OF THE INVENTION

The present invention is directed to an emergency evacuation system that includes a cooperating arrangement of telescopically extendable sections for providing a substantially horizontal walkway between two adjacent buildings at one or more floor levels above the ground floor, thereby allowing occupants in either building to safely, easily and systematically evacuate the building and enter the adjacent building in an emergency without having to descend stairs all the way to the ground floor of the building being evacuated. The telescopically extendable sections of the walkway are normally stowed in retracted arrangement (i.e., one within the other) within a room or an interior compartment within the flooring or infrastructure of the first building. Each section of the walkway includes a deck and collapsible safety walls along opposite sides of the deck.

When the emergency walkway is deployed, the safety walls raise and lock into an operable, vertical position along the entire length of the walkway, from the first building to the adjacent building. A first one of the extendable walkway sections may be mounted on a rotatable base, within the first building, to allow adjusted angular positioning of the extended walkway so that the opposite end docks at the desired location on the side of the adjacent building. In a preferred embodiment, emergency access to both the first building and the adjacent building, at opposite ends of the walkway, is normally closed and only opens when the emergency evacuation system is deployed.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view showing the safe walkway of the emergency evacuation system of the present invention deployed and extending from a first building to an adjacent second building with safety walls erected;

FIG. 2 is a front elevational view showing an emergency exit with a closeable access door along the side of the first building, with the extendable safe walkway shown in a collapsed, stowed position within a compartment in the side of the building below the emergency exit;

FIG. 3 is a perspective view showing the deck sections of the safe walkway extending outwardly from the side of the first building, at or just below the emergency exit;

FIG. 4A is an isolated perspective view showing a series of extended sections of the safe walkway extended and with the left safety wall moving from the collapsed position to the raised, operable position;

FIG. 4B shows the left safety wall along the safe walkway locked in the raised, operable position;

FIG. 5 is a perspective view looking out through the emergency exit of the first building and towards the emergency access opening of the adjacent building and showing the safe walkway deployed and extending from the emergency exit of the first building to the emergency access opening of the adjacent building, with the left and right safety walls raised in the upright, locked, and operable position;

FIG. 6 is a side perspective view showing a portion of the extended safe walkway with a first section of the walkway mounted on a rotatable base within the first building;

FIG. 7A is a top plan view showing the safe walkway of FIG. 7A in a retracted, stowed mode within the first building;

FIG. 7B is a top plan view showing the safe walkway in the extended, deployed position and illustrating angular adjusted movement to the left or right, as illustrated by the arrows, achieved with the use of the rotatable base;

FIG. 8 is a top plan view showing the safe walkway deployed and extending at an angular position from the first building to the access opening of the adjacent building, and wherein angular positioning of the walkway is achieved with the rotating base of FIG. 6; and

FIG. 9 is a front perspective view, looking at the side of the building, showing the walkway in the retracted, stowed mode within a designated room or compartment.

Like reference numeral refer to like parts throughout the several views of the drawings.

### DETAILED DESCRIPTION OF THE PREFERRED EMBODIMENTS

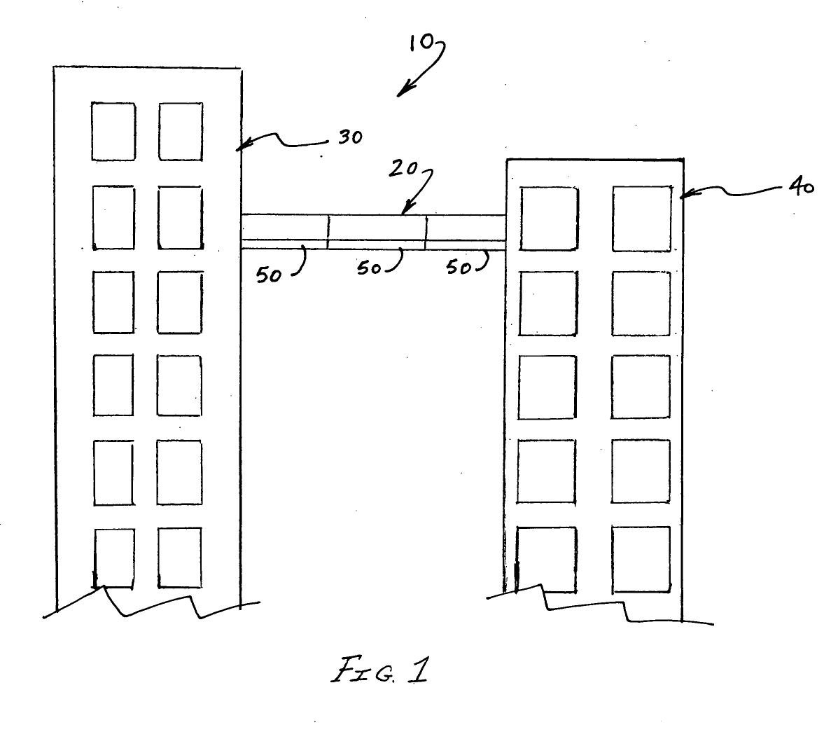

According to the several views of the drawings, an emergency evacuation system for multi-story buildings is shown and is generally indicated as 10. The emergency evacuation system includes an extendable walkway 20, defining an escape walkway, that extends from a first building 30 to an adjacent building 40 at one or more floors above the ground floor level, as shown in FIG. 1. When deployed, as shown in FIG. 1, the extended walkway 20 allows occupants in either the first building 30 or the adjacent building 40 to safely, easily and calmly walk across the walkway 20 and to an entry on the side of the other building.

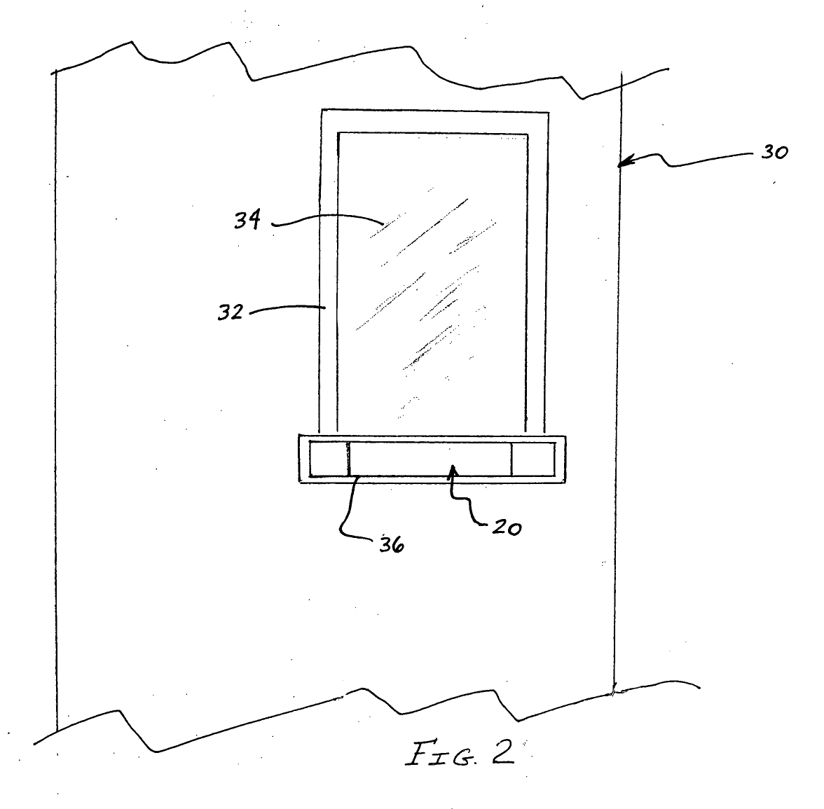

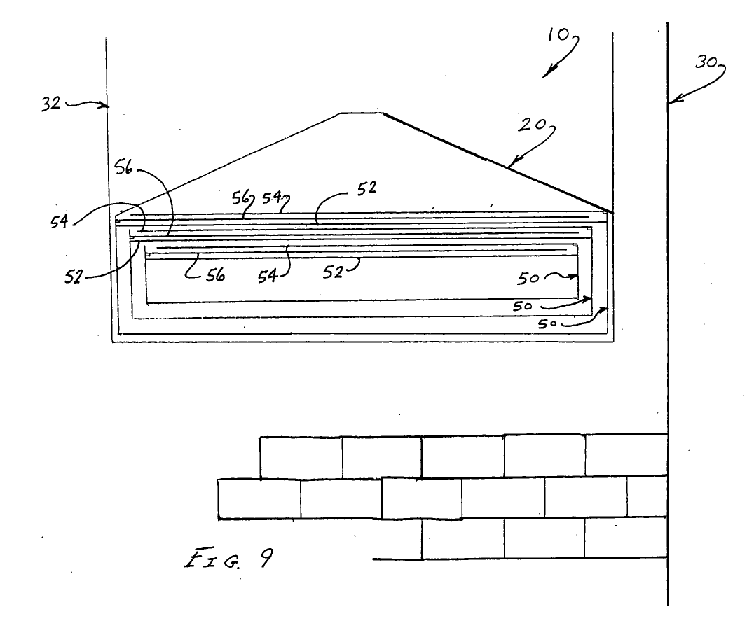

As seen in FIG. 2, the emergency exit 32 on the side of the first building 30 may be provided with a door structure 34 that remains closed and cannot be opened until the walkway 20 is fully extended and docked to the side of the adjacent building 40, in alignment with the safe entry 42. The extendable walkway 20 may be contained within a room behind the emergency exit door 34, within a compartment 36 below the emergency exit door as seen in FIGS. 2 and 9, or within the flooring or infrastructure of the first building 30.

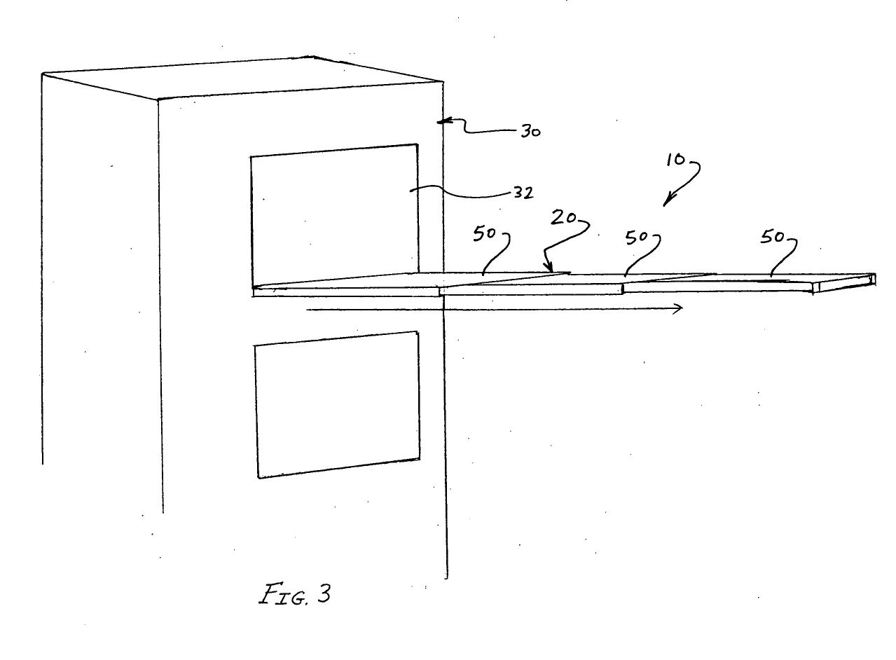

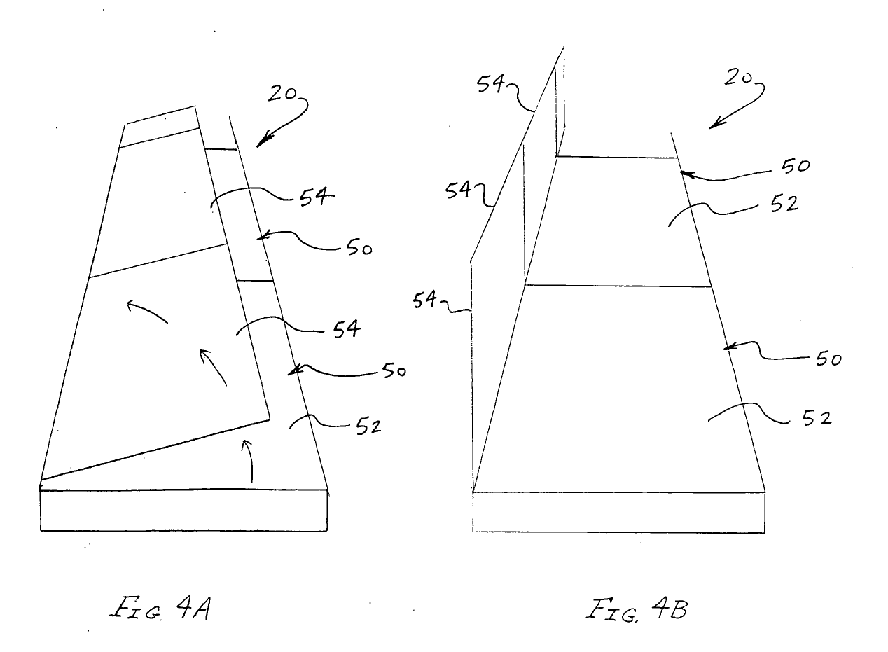

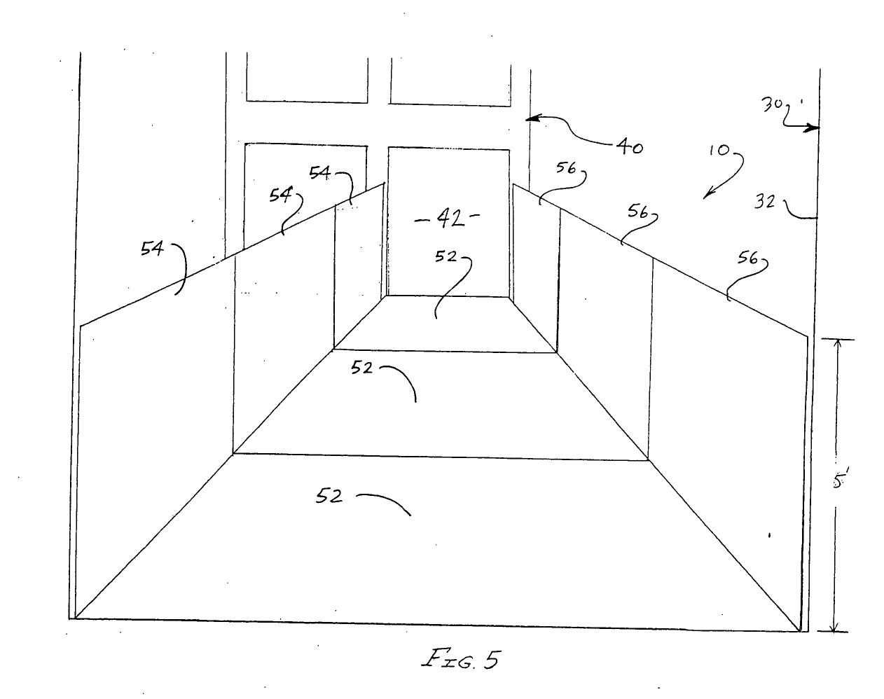

When the emergency evacuation system 10 is deployed, by operating an emergency control switch or other device within the first building 30, the extendable walkway 20 is deployed from the side of the first building 30. In a preferred embodiment, the extendable walkway 20 includes two or more extending sections 50 that move outwardly, as depicted in FIG. 3, in a telescoping manner. Telescopic, outward and retracting movement of the extending sections 50 of the walkway 20 can be achieved with the use of hydraulics, an electric motor with cable and pulleys, motorized rollers or a screw shaft. Other means for extending and retracting the sections 50 of the walkway 20 are contemplated within the spirit or scope of the invention. Movement of the extending sections 50 relative to the other sections 50 can be achieved by ball bearing slides, rollers, or other slide structural arrangements with a suitable lubricant to promote smooth sliding movement without excess friction or jamming. The sections 50 can be connected to one another by cooperating slide elements on the sides and/or the bottoms of each section. As seen in FIGS. 4A-5, the telescopically extending sections 50 of the safe walkway 20 include a deck 52 defining a walking surface, and collapsible safety walls 54, 56 on opposite sides of the deck 52. Referring to FIGS. 4A and 9, the safety walls 54, 56 are normally stowed in a collapsed position, in stacked arrangement on top of the deck 52. When the walkway 20 is deployed, a first one of the safety walls 54 raises up to a vertical position and locks into place, as shown in FIG. 4B. Next, the opposite safety wall 56 (see FIG. 5) raises and locks into position, so that both left and right safety walls 54, 56 are raised and locked in the vertical position, extending along the entire length of the walkway 20 from the first building 30 to the adjacent building 40, as seen in FIG. 5. In a preferred embodiment, the safety walls 54, 56 are approximately five (5) feet in height in order to provide a level of comfort to those traversing the walkway 20.

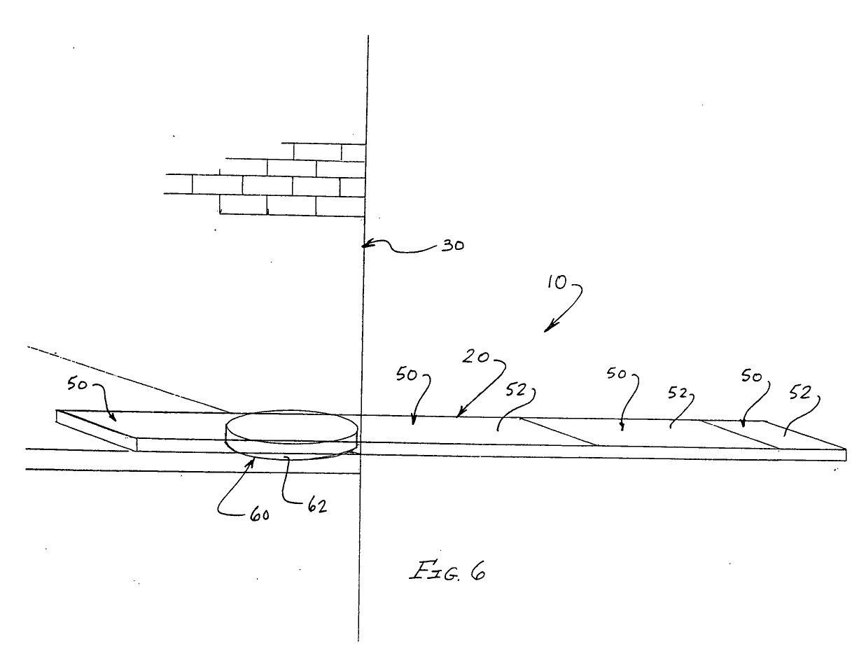

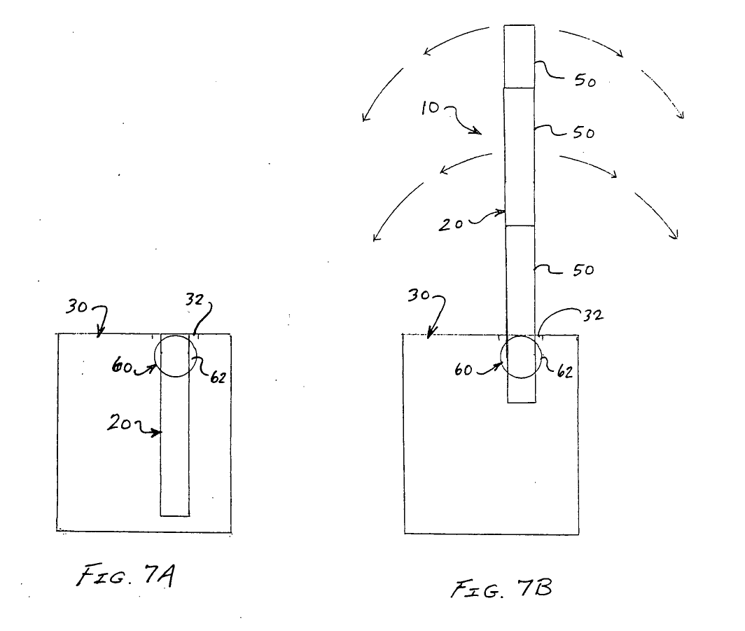

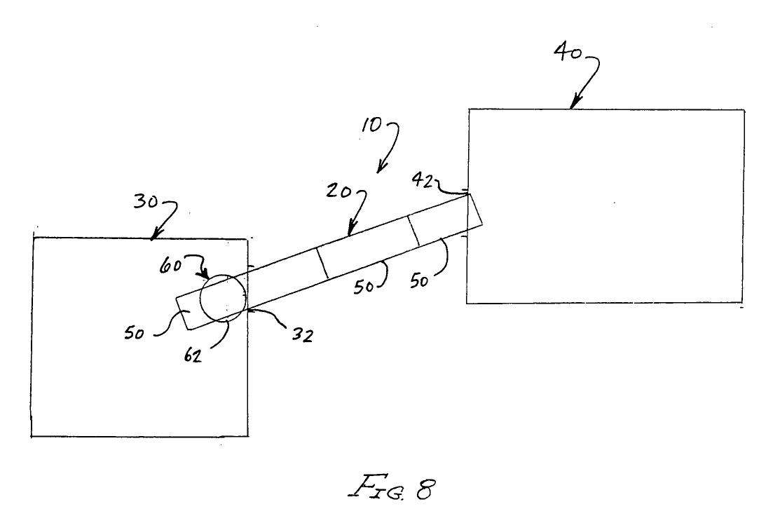

Referring to FIGS. 6-8, a means for adjusting the angle of the extending walkway 20 relative to the first building 30 and adjacent building 40 is shown and is generally indicated as 60. In a preferred embodiment, the angular adjustment assembly 60 includes a rotatable base or turntable 62 installed within the designated room or compartment of the first building 30. A first one of the extending sections 50 of the safe walkway 20 is mounted to the turntable 62 and rotates with the turntable, either to the left or right, as depicted by the directional arrows in FIG. 7B. This allows the extended safe walkway 20 to be aligned with the safe entry 42 of the adjacent building 40. For example, referring to FIG. 8, if the adjacent building 40 is situated in staggered position relative to the first building 30 and the safe entry 42 does not line up straight with the emergency exit 32, the extended safe walkway 20 can be turned, by operating rotation of the turntable 62, until the end of the safe walkway 20 meets the safe entry 42. The adjustment assembly 60 may further be provided with an elevation adjustment in order to slightly raise or lower the distal end of the extended safe walkway 20 in the event the safe entry of the adjacent building 40 is slightly higher or lower than the level of the emergency exit 32 of the first building 30.

While the present invention has been shown and described in accordance with preferred and practical embodiments thereof, it is recognized that departures from the instant disclosure are fully contemplated within the spirit and scope of the invention.

What is claimed is:

1. An emergency evacuation system for multi-story buildings comprising:
an extendable walkway moveably operable by force between a collapsed, stowed position within a first multi-story building and an extended, deployed position spanning between the first multi-story building and a second multi-story building; and
said extendable walkway including a plurality of telescoping sections, and each of said sections including a deck defining a walking surface and opposite safety barriers along left and right sides of said deck, and said opposite safety barriers being operatively moveable between a stowed, collapsed position in stacked arrangement on top of said deck, and a vertically deployed position extending upwardly from the left and right sides of the deck.

2. The emergency evacuation system as recited in claim 1 further comprising:
an emergency exit at the first multi-story building for providing access to said extendable walkway when in said extended, deployed position.

3. The emergency evacuation system as recited in claim 2 wherein said emergency exit includes a door that is normally closed to prevent occupants of the first multi-story building from exiting from said emergency exit and, said door being operable to an open position when said extendable walkway is in said extended, deployed position to thereby allow the occupants of the first multi-story building to safely exit through said emergency exit and travel across said extendable walkway to the second multi-story building.

4. The emergency evacuation system as recited in claim 3 further comprising:
a safe entry in the second multi-story building for allowing passage of the occupants between said extendable walkway and the second multi-story building.

5. The emergency evacuation system as recited in claim 4 further comprising:
an entry door at said safe entry, and said entry door being normally closed and operable to an open position when said extendable walkway is in said extended, deployed position.

6. The emergency evacuation system as recited in claim 5 further comprising:
an angular adjustment assembly for adjusting the position of the said extendable walkway when in said extended, deployed position to align said extendable walkway with said safe entry at the second multi-story building.

7. The emergency evacuation system as recited in claim 6 further comprising:
a compartment in the first multi-story building for storing said extendable walkway in said collapsed, stowed position.

8. An emergency evacuation system for multi-story buildings comprising:
an extendable walkway moveably operable by force between a collapsed, stowed position within a first multi-story building and an extended, deployed position spanning between the first multi-story building and a second multi-story building;
said extendable walkway including a plurality of telescoping sections, and each of said sections including a deck defining a walking surface and opposite safety barriers along left and right sides of said deck, and said opposite safety barriers being operatively moveable between a stowed, collapsed position in stacked arrangement on top of said deck, and a vertically deployed position extending upwardly from the left and right sides of the deck;
an angular adjustment assembly for adjusting the assembly of said extendable walkway when in said extended, deployed position; and
a compartment in the first multi-story building for storing said extendable walkway in said collapsed, stowed position.

9. The emergency evacuation system as recited in claim 8 further comprising:
an emergency exit at the first multi-story building for providing access to said extendable walkway when in said extended, deployed position.

10. The emergency evacuation system as recited in claim 9 wherein said emergency exit includes a door that is normally closed to prevent occupants of the first multi-story building from exiting from said emergency exit and, said door being operable to an open position when said extendable walkway is in said extended, deployed position to thereby allow the occupants of the first multi-story building to safely exit through said emergency exit and travel across said extendable walkway to the second multi-story building.

11. The emergency evacuation system as recited in claim 10 further comprising:
a safe entry in the second multi-story building for allowing passage of the occupants between said extendable walkway and the second multi-story building.

12. The emergency evacuation system as recited in claim 11 further comprising:
an entry door at said safe entry, and said entry door being normally closed and operable to an open position when said extendable walkway is in said extended, deployed position.
